(19) United States
(12) Patent Application Publication
(10) Pub. No.: US 2025/0229488 A1
(43) Pub. Date: Jul. 17, 2025

(54) A device for moving an extruding unit of an additive production machine

(71) Applicant: Mark One S.R.L., Cesena (IT)

(72) Inventors: Marco Zani, Cesena (IT); Federico Nanetti, Cesena (IT); Edoardo Ida'

(73) Assignee: Mark One S.R.L., Cesena (IT)

(21) Appl. No.: 18/703,212

(22) PCT Filed: Oct. 20, 2022
(86) PCT No.: PCT/IB2022/060090

§ 371 Date: Apr. 19, 2024

(30) Foreign Application Priority Data
Oct. 20, 2021 (IT) 102021000026930

(51) Int. Cl. B29C 64/232; B29C 64/118; B29C 64/236; B33Y 30/00

(52) U.S. Cl. CPC B29C 64/232; B29C 64/236; B33Y 30/00; B29C 64/118

(57) ABSTRACT

A device for moving an extruding unit of an additive production machine includes a frame that includes at least a first guide positioned along a first direction (X) and a second guide positioned along a second direction (Y) perpendicular to the first direction (X); a body for supporting the extruding unit slidably constrained at least to the first guide of the frame; at least a first motor-driven unit, a second motor-driven unit, a third motor-riven unit, a fourth motor-driven unit or alternatively a fourth idle unit, and a way to transmit the motion of the motor-driven units to move the supporting body of the extruding unit with respect to the frame, and to move the first guide with respect to the second guide.

### TECHNICAL FIELD

The invention relates to a device for moving an extruding unit of an additive production machine.

### BACKGROUND ART

The most widespread movement devices for this category of goods use synchronous belts for moving the extruding unit mainly on a predetermined plane.

A known method of movement, known as the “serial” method, of the extruding unit comprises motor-driven axes which are able to distribute the movement in series along these axes by means of belts which are completely independent of each other.

The use of these types of movement devices requires considerable installation space.

Nowadays, the most commonly used movement mode is the so-called “parallel method” in which the axes of the machine are all fixed to the frame and distribute the motion to the extruder in a concurrent manner, using one or more belts driven on fixed or movable elements.

A known movement device, to which reference will be made with the name “Hbot”, comprises the two-way movement of a print head using a single interrupted belt, the ends of which are fixed to the head itself.

The two-way motion of the head is controlled by the combination of the drives of two motors.

The head, in fact, can slide along a direction thanks to the coupling with guides or bars. These bars connect two components which slide in the other direction on another two bars which, on the other hand, are fixed in the form of a frame. Through some suitably positioned pulleys, the belt moves along a path winding around both the motors. The particular H-shaped trajectory of the belt gives its name to the machine, Hbot.

The Hbot system has some critical issues, of which the most important is without doubt the imbalance in dynamic conditions which does not allow the system to maintain an optimum precision when reaching high operating speeds.

Another known movement system is called “CoreXY” and uses two belts for moving the extruder each controlled by a respective motor.

The belts are positioned on different planes and heights to form a cross path.

This particular geometry solves the critical issues related to the Hbot solution, including the imbalance, but introduces new ones.

The CoreXY system results in a difficult assembly and is certainly a bulky and not very compact structure.

### AIM OF THE INVENTION

In this technical context, the Applicant has felt the need to provide a new device for moving an extruding unit of an additive production machine comprising the technical features described according to independent claim 1.

Advantageously, the device makes it possible to achieve a perfect dynamic balancing, that is to say, the forces which do not contribute to the induced movement are in equilibrium and are not discharged in any way on the frame (neglecting friction), even at high performance speeds, thereby guaranteeing an excellent machining precision.

### BRIEF DESCRIPTION OF THE DRAWINGS

The features of the invention are clearly described in the claims below and its advantages are more apparent from the detailed description which follows, with reference to the accompanying drawings which illustrate a preferred, non-limiting example embodiment of the invention and in which:

FIG. 1 is a schematic view of an embodiment of the device according to the invention;

FIG. 2 is a schematic representation of the device illustrated in FIG. 1 according to a dynamic example;

FIG. 3 is a schematic representation of the device illustrated in FIG. 1 in order to highlight further details;

FIG. 4 is a schematic view of an embodiment of the device according to the invention;

FIG. 5 is a schematic representation of the device illustrated in FIG. 4 according to a dynamic example;

FIG. 6 is a schematic representation of the device illustrated in FIG. 4 in order to highlight further details.

### DETAILED DESCRIPTION OF PREFERRED EMBODIMENTS OF THE INVENTION

With reference to the accompanying drawings, the numeral 1 denotes a device for moving an extruding unit of an additive production machine (referred to more simply in the invention, but without limiting the scope of the invention, as a device) and the numeral 10 denotes the extruding unit.

The additive production machine can be, for example, in a non-limiting manner, a machine that uses FFF (Fused Filament Fabrication) technology.

According to the invention, the device 1 comprises a frame 100.

The frame 100 which comprises at least a first guide 101 positioned along a first direction X and a second guide 102 positioned along a second direction Y.

The second direction Y is perpendicular to the first direction X.

The first direction X and the second direction Y define a horizontal work surface of the extruding unit 10.

The device 1 comprises a supporting body 2 for the extruding unit 10.

The body 2 is slidably constrained at least to the first guide 101 of the frame 100.

The device 1 comprises at least a first motor-driven unit 11, a second motor-driven unit 12 and a third motor-driven unit 13.

According to an aspect of the invention, the first unit 11, the second unit 12 and the third unit 13 comprise respective toothed pulleys.

The device 1 comprises motion transmission means 3.

The motion transmission means 3 are configured to move the supporting body 2 of the extruding unit 10 with respect to the frame 100.

The motion transmission means 3 are configured to move the first guide 101 with respect to the second guide 102.

The motion transmission means 3 comprise a flexible element 4 and a plurality of idle elements 5.

According to an aspect of the invention, the idle means 5 comprise smooth and/or toothed pulleys.

Each idle unit 5 rotates about a respective axis of rotation 5a.

The axes of rotation 5a are aligned in pairs along a direction parallel to the first direction X or the second direction Y.

Preferably, the pulleys are connected to the frame 100 by rolling bearings.

Advantageously, the pulleys mounted on rolling bearings make it possible to reduce friction during the movement step.

The flexible element 4 is a single body supported at least by the first unit 11, by the second unit 12, by the third unit 13 and by the idle units 5.

The supporting body 2 supports at least a part of the idle units 5 and the flexible element 4.

The flexible element 4 defines a continuous closed path 6.

Preferably, the flexible element 4 is a belt.

Advantageously, a single flexible element on a continuous and closed path makes the device more compact.

The continuous closed path 6 extends at least partly along a direction parallel to the first direction X of extension of the first guide 101 and at least partly along a direction parallel to the second direction Y of extension of the second guide 102.

Advantageously, the flexible element 4 is positioned on a single plane, giving compactness to the device.

The first unit 11, the second unit 12 and the third unit 13 are supported by the frame 100.

According to a preferred embodiment, the first unit 11 is positioned symmetrical to the second unit 12 with respect to a first axis A1 of symmetry parallel to the first direction X of the first guide 101.

According to a preferred embodiment, the second unit 12 is positioned symmetrical to the third unit 13 with respect to a second axis A2 of symmetry parallel to the second direction Y of the second guide 102.

According to an aspect of the invention, the device 1 comprises a first drive unit 7, illustrated schematically in FIG. 1, of the first unit 11 and of the third unit 13.

The first drive unit 7 is configured to impart the motion, according to a defined value, to the first unit 11 in a first direction of movement and the third unit 13 in a second direction of movement opposite to the first direction of the first unit 11.

In other words, the first drive unit 7 is configured to impart motion to the first unit 11 and to the third unit 13 according to the same absolute value of intensity and opposite direction.

According to a preferred embodiment, the first drive unit 7 comprises an electric motor.

Preferably, the motor of the first unit 11 and the motor of the third unit 13 is a stepper motor.

According to an aspect of the invention, the device 1 comprises a fourth motor-driven unit 14, or fourth idle unit 14, supported by the frame 100. The fourth motor-driven unit 14, or fourth idle unit 14, comprises a respective toothed pulley.

According to a preferred embodiment, the fourth unit 14 is positioned in such a way as to be symmetrical to the third unit 13 with respect to the first axis A1 of symmetry.

The fourth unit 14 is positioned in such a way as to be symmetrical to the first unit 11 with respect to the second axis A2 of symmetry.

The fourth unit 14 is configured to support the flexible element 4.

According to an aspect of the invention, the device 1 comprises a second drive unit 8, illustrated schematically in FIG. 1, at least of the second unit 12.

According to an aspect of the invention, the second drive unit 8 drives the second unit 12 and the fourth unit 14, if the fourth unit 14 is motor-driven.

The second drive unit 8 is configured to impart the motion, according to a defined value, to the second unit 12 in a first direction of movement and the fourth unit 14 in a second direction of movement opposite to the first direction of the second unit 12.

In other words, the second drive unit 8 is configured to impart motion to the second unit 12 and to the fourth unit 14 according to the same absolute value of intensity and opposite direction.

It should be noted that the expression “first direction of movement” referred to the first unit 11 and to the second unit 12 does not imply that it is the same direction of movement for the first unit 11 and for the second unit 12; in other words, the first direction of movement of the first unit 11 may be concordant or different with respect to the first direction of movement of the second unit 12.

The same consideration applies to the expression “second direction of movement” of the third unit 13 and of the fourth unit 14.

According to a preferred embodiment, the second drive unit 8 comprises an electric motor.

Preferably, the motor of the second unit 12 and of the fourth unit 14 is a stepper motor.

According to an aspect of the invention, the first drive unit 7 and the second drive unit 8 are independent of each other.

The first unit 11, the second unit 12, the third unit 13 and the fourth unit 14 are configured to rotate in a respective direction of rotation.

The first drive unit 7 is configured to rotate the first unit 11 and the third unit 13, according to a same angular movement, in absolute value, and opposite directions to each other.

The second drive unit 8 is configured to rotate the second unit 12 according to an angular movement.

According to an aspect of the invention, the second drive unit 8 is configured to rotate the second unit 12 and the fourth unit 14, according to a same angular movement, in absolute value and in opposite directions.

Each unit (11, 12, 13, 14) rotates about a respective axis of rotation (11a, 12a, 13a, 14a).

The axes of rotation 11a and 12a, respectively of the first unit 11 and of the second unit 12, are aligned along a direction parallel to the second direction Y.

The axes of rotation 13a and 14a, respectively of the third unit 13 and of the fourth unit 14, are aligned along a direction parallel to the second direction Y.

The motor-driven units (11, 12, 13, 14) have the same working diameter with respect to each other.

The idle unit 14 has the same working diameter as the motor-driven units (11, 12, 13).

The expression “working diameter” is used to mean the diameter around which the flexible element 4 is partly wound.

The smooth pulleys 5 have the same working diameter with respect to each other.

The toothed pulleys 5 have the same working diameter with respect to each other.

In other words, there are at most three different working diameters, one for the motor-driven units (11, 12, 13, 14), one for the smooth pulleys 5 and one for the toothed pulleys 5.

According to a preferred embodiment, all the pulleys, smooth and toothed, have the same working diameter.

In other words, all the motor-driven units (11, 12, 13, 14) and the idle units (5, 14) have the same working diameter.

It should be noted that a same working diameter for all the pulleys, together with the alignment between the axes of rotation of the pulleys along a direction parallel to the first direction X or to the second direction Y, allows all the stretches of the path defined by the flexible element 4 between one pulley and the next to be parallel to the first direction X or to the second direction Y.

The device 1 is configured to be controlled by means of the first drive unit 7 and the second drive unit 8.

The device 1 comprises a hardware unit (not illustrated in the accompanying drawings) configured to control the first drive unit 7 and the second drive unit 8.

Advantageously, the directions of rotation of the motor-driven units can be controlled by means of the hardware unit.

Advantageously, the control by means of the hardware unit may be performed remotely.

Advantageously, the control of the device 1 by means of only two drives makes it possible not to have particular complications at control level.

The motor-driven units of the device 1 according to the invention are configured so that their motion is not independent, but driven by only two drive units. The drive units drive the motor-driven units in pairs.

These relations between motor-driven units and drive units apply for each motion condition of the supporting body 2 of the extruding unit 10.

According to an aspect of the invention, and preferably, the distance between the first unit 11 and the second unit 12 is the same as between the third unit 13 and the fourth unit 14.

According to an aspect of the invention, the distance between the second unit 12 and the third unit 13 is the same as between the first unit 11 and the fourth unit 14.

Advantageously, the multiple symmetries of the device which are highlighted in the description give the device production and maintenance simplicity.

Advantageously, the multiple symmetries of the device which are highlighted in the description give the device a high level of stability and excellent balancing.

According to an aspect of the invention, the motion transmission means 3 comprise a first body 21.

The first body 21 comprises at least part of the idle units 5 and of the flexible element 4.

The supporting body 2 of the extruding unit 10 comprises at least part of the idle units 5 and the flexible element 4.

The first body 21 is slidably constrained to the second guide 102 and is connected to the first guide 101.

The first body 21 is interposed between third unit 13 and fourth unit 14.

According to an aspect of the invention, the frame 100 comprises at least a third guide 103 positioned parallel to the second direction Y of the second guide 102.

The motion transmission means 3 comprise a second body 22.

The second body 22 comprises at least part of the idle units 5 and of the flexible element 4.

The second body 22 is slidably constrained to the third guide 103 and is connected to the first guide 101.

The second body 22 is interposed between the first unit 11 and the second unit 12.

The second guide 102 and the third guide 103 are relatively fixed with respect to the movement of the first guide 101. According to an aspect of the invention, the closed path 6, defined by the flexible element 4, comprises at least a first branch 201, a second branch 202, a third branch 203 and a fourth branch 204.

The first branch 201, the second branch 202, the third branch 203 and the fourth branch 204 extend along a direction parallel to the second direction Y of the second guide 102.

The closed continuous path 6 comprises at least a fifth branch 205, a sixth branch 206, a seventh branch 207 and an eighth branch 208.

The fifth branch 205, the sixth branch 206, the seventh branch 207 and the eighth branch 208 extend along a direction parallel to the first direction X of the first guide 101.

In particular, the first branch 201 is connected to at least one idle unit of the second body 22.

In particular, the second branch 202 is connected to at least one idle unit of the second body 22.

In particular, the third branch 203 is connected to at least one idle unit of the first body 21.

In particular, the fourth branch 204 is connected to at least one idle unit of the first body 21.

With reference in particular to the first embodiment illustrated in FIG. 1, but without limiting the scope of the invention, the closed path 6 is described more specifically.

The first branch 201 comprises a first stretch 301 which connects an idle unit 5 positioned on the second body 22 to the first unit 11 and also comprises a second stretch 302 which connects the first unit 11 to an idle unit 5 positioned on the second body 22.

The first stretch 301 and the second stretch 302 are positioned along a direction parallel to the second direction Y.

The second branch 202 comprises a third stretch 303 which connects an idle unit 5 positioned on the second body 22 to the second unit 12 and also comprises a fourth stretch 304 which connects the second unit 12 to an idle unit 5 positioned on the second body 22.

The third stretch 303 and the fourth stretch 304 are positioned along a direction parallel to the second direction Y.

The third branch 203 comprises a fifth stretch 305 which connects an idle unit 5 positioned on the first body 21 to the third unit 13 and also comprises a sixth stretch 306 which connects the third unit 13 to an idle unit 5 positioned on the first body 21.

The fifth stretch 305 and the sixth stretch 306 are positioned along a direction parallel to the second direction Y.

The fourth branch 204 comprises a seventh stretch 307 which connects an idle unit 5 positioned on the first body 21 to the fourth unit 14 and also comprises an eighth stretch 308 which connects the fourth unit 14 to an idle unit 5 positioned on the first body 21.

The seventh stretch 307 and the eighth stretch 308 are positioned along a direction parallel to the second direction Y.

The fifth branch 205 comprises a ninth unit 309 which connects an idle unit 5 positioned on the second body 22 to an idle unit 5 positioned on the supporting body 2 and also comprises a tenth stretch 310 which connects an idle unit 5 positioned on the supporting body 2 to an idle unit 5 positioned on the second body 22.

The ninth stretch 309 and the tenth stretch 310 are positioned along a direction parallel to the first direction X.

The sixth branch 205 comprises an eleventh stretch 311 which connects an idle unit 5 positioned on the first body 21 to an idle unit 5 positioned on the supporting body 2 and also comprises a twelfth stretch 312 which connects an idle unit 5 positioned on the supporting body 2 to an idle unit 5 positioned on the first body 21.

The eleventh stretch 311 and the twelfth stretch 312 are positioned along a direction parallel to the first direction X.

The seventh branch 207 comprises a thirteenth stretch 313 which connects an idle unit 5 positioned on the second body 22 to an idle unit 5 positioned on the first body 21.

The thirteenth stretch 313 is positioned along a direction parallel to the first direction X.

The eighth branch 208 comprises a fourteenth stretch 314 which connects an idle unit 5 positioned on the first body 21 to an idle unit 5 positioned on the second body 22.

The fourteenth stretch 314 is positioned along a direction parallel to the first direction X.

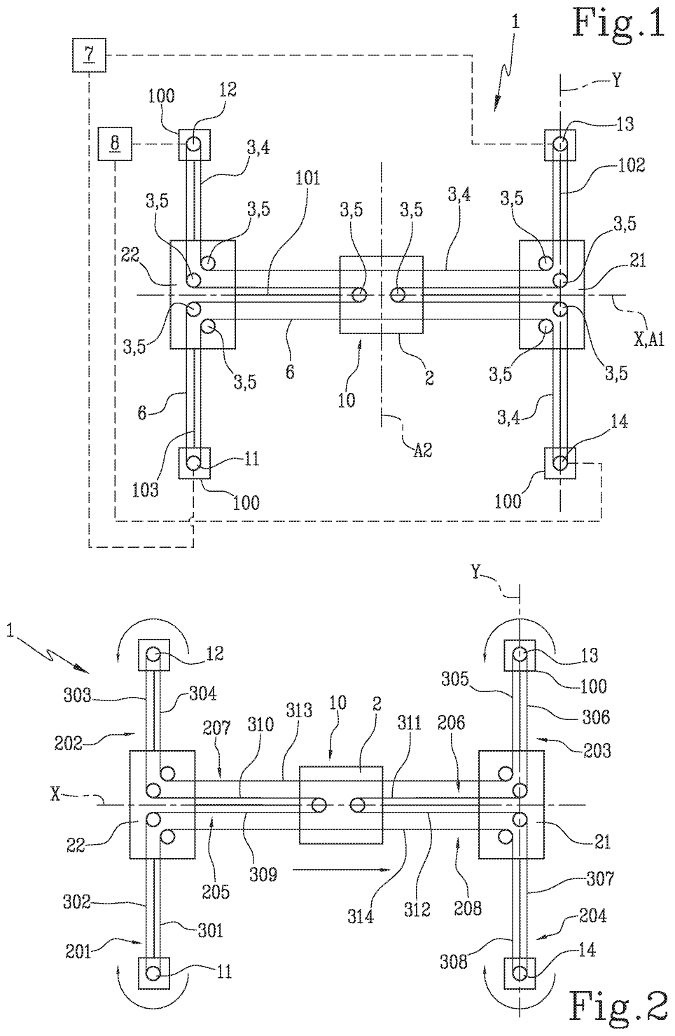

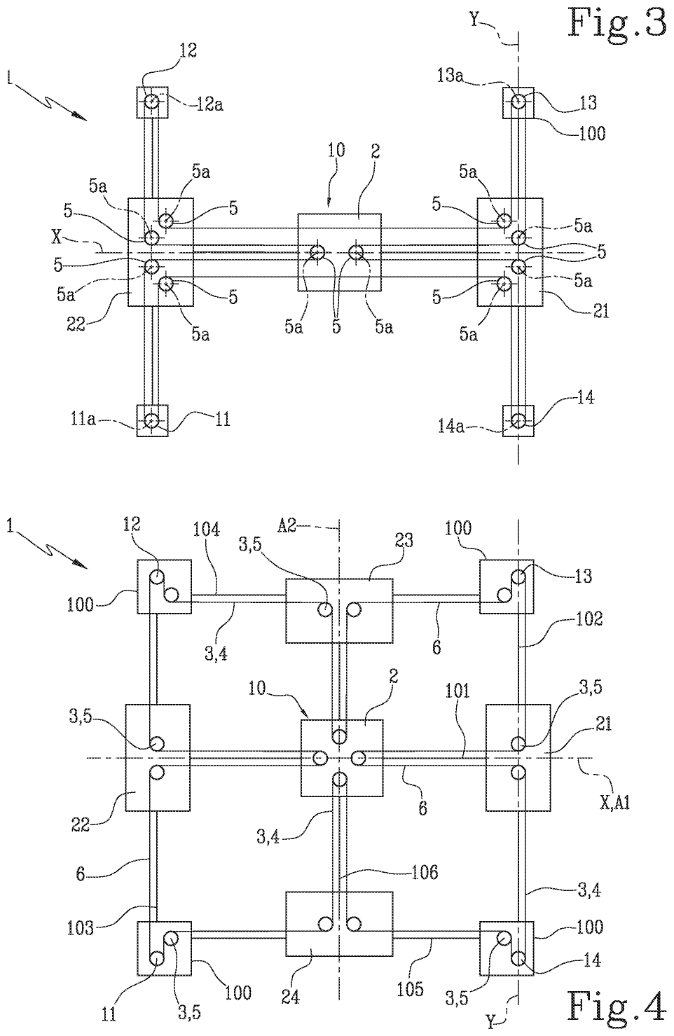

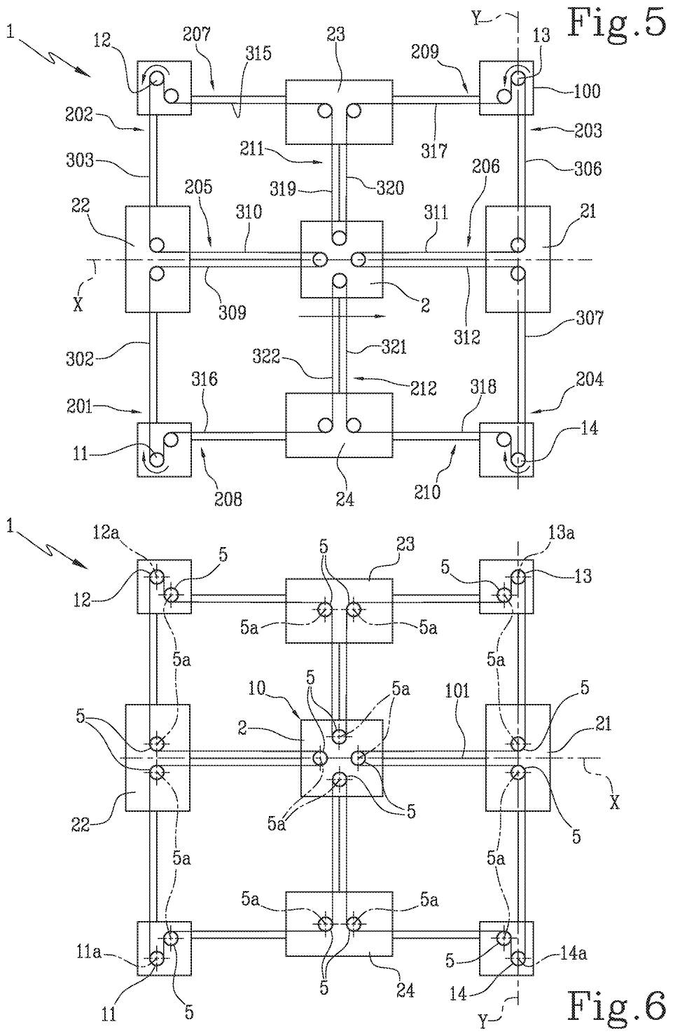

FIG. 2 describes a non-limiting example of a configuration of the first embodiment of the device 1 for determining a movement of the supporting body 2 and therefore of the extruding unit 10.

By means of the first drive unit 7, the first unit 11 is rotated in a clockwise direction and the third unit 13 is rotated in an anticlockwise direction.

By means of the second drive unit 8, the second unit 12 is rotated in an anticlockwise direction and the fourth unit 14 is rotated in a clockwise direction.

This configuration of the rotations of the motor-driven units (11, 12, 13, 14) determines a resulting force on the supporting body 2 in a direction parallel to the first direction X and with an orientation from the second body 22 to the first body 21.

In other words, according to the drawing in FIG. 2 and the references indicated in it, there is a resultant on the supporting body 2, and therefore on the extruding unit 10, towards the right.

The direction and orientation of the resultant of the forces on the supporting body 2 determine the movement of the supporting body 2 in the same direction and orientation and with a speed which depends on the speed of rotation of the motor-driven units (11, 12, 13, 14).

More specifically, the resultant is determined by the tension of the stretches of the flexible element 4 on the basis of the directions of rotation imparted to the motor-driven units (11, 12, 13, 14).

When the device 1 is in use, that is to say, when it is actuated by the drive units 7, 8, the tension of at least part of the stretches of the flexible element 4 is modified. In fact, part of the stretches of the flexible element 4 modifies the tension on the basis of the directions of rotation imparted by the motor-driven units (11, 12, 13, 14).

Greater or lesser tensions of the stretches of the flexible element 4 translate into forces of different intensity applied to the first body 21, to the second body 22 and to the supporting body 2 which are configured to be able to slide on the respective guides (102, 103, 101).

Described below are the forces applied to the first body 21, to the second body 22 and to the supporting body 2 due to the tensions of the various stretches of the flexible element 4 according to the directions of rotation of the motor-driven units (11, 12, 13, 14) imparted in this example.

It should be noted that the “increase”, or “decrease” of the tension of a stretch of the flexible element 4 means that the static tension of the stretch is exceeded or lowered.

The term “static tension” means the tension of the flexible element 4 at rest, before starting the motor-driven units.

The tension of the second stretch 302 decreases and translates into a force on the second body 22 of equal intensity and direction, but with the opposite orientation, with respect to the force which derives from the tension of the third stretch 303. In fact, the tension of the third stretch 303 also reduces in the same way. The first stretch 301 and fourth stretch 304 do not modify their tension and do not involve forces on the second body 22. For this reason, a zero force is applied to the second body 22, that is to say, it is in equilibrium, with respect to the second direction Y. This results in a zero force along the second direction Y exerted by the second body 22 on the first guide 101 and in particular on the supporting body 2. The tension of the sixth stretch 306 increases and translates into a force on the first body 21 of equal intensity and direction, but with the opposite orientation, with respect to the force which derives from the tension of the seventh stretch 307. In fact, the tension of the seventh stretch 307 also increases in the same way. The fifth stretch 305 and eighth stretch 308 do not modify their tension and do not involve forces on the first body 21. For this reason, a zero force is applied to the first body 21, that is to say, it is in equilibrium, with respect to the second direction Y. This results in a zero force along the second direction Y exerted by the first body 21 on the first guide 101 and in particular on the supporting body 2.

The tensions of the ninth stretch 309 and of the tenth stretch 310 decrease, whilst the tensions of the eleventh stretch 311 and of the twelfth stretch 312 increase. This translates into a resulting force on the supporting body 2 along the first direction X towards the right, that is to say, towards the first body 21.

The thirteenth stretch 313 and fourteenth stretch 314 do not modify their tension and do not involve forces on the supporting body 2.

Repeating, for greater clarity, each force along the second direction Y corresponds to an equal and opposite force, that is to say, there is a zero resultant force along the second direction Y, whilst there is non-zero resulting force along the first direction X towards the first body 21.

This results in a movement of the supporting body 2, and therefore of the extruding unit 10, along the first guide 101 towards the first body 21, that is to say, towards the right.

Advantageously, as is evident from the description, in use of the device for moving the extruding unit 10 along the first direction X towards the first body 21, there is a balancing of all the forces along the second direction Y.

Advantageously, this dynamic balancing allows the extruding unit to move as required without vibrations, imprecisions, unwanted translations and oscillations.

Advantageously, moving without unbalancing allows the device to move the extruding unit with greater speed without consequently reducing the precision and control of the extruding unit during the operating step.

It is possible to move the extruding unit 10 according to other uses according to the directions of rotation imparted to the motor-driven units (11, 12, 13, 14). For each movement it is possible to make considerations on the tensions of the stretches of the flexible element 4 and on the forces according to what is described in the above example.

In order to obtain a movement of the supporting body 2, and therefore of the extruding unit 10, along the first direction X of the first guide 101 towards the second body 22:

by means of the first drive unit 7, the first unit 11 is rotated in an anticlockwise direction and the third unit 13 is rotated in a clockwise direction;

by means of the second drive unit 8, the second unit 12 is rotated in a clockwise direction and the fourth unit 14 is rotated in an anticlockwise direction.

In order to obtain a movement of the supporting body 2, and therefore of the extruding unit 10, along the second direction Y in such a way that the first body 21 and the second body 22 slide on the respective guides 102, 103 respectively towards the third unit 13 and towards the second unit 12: by means of the first drive unit 7, the first unit 11 is rotated in an anticlockwise direction and the third unit 13 is rotated in a clockwise direction;

by means of the second drive unit 8, the second unit 12 is rotated in an anticlockwise direction and the fourth unit 14 is rotated in a clockwise direction.

In order to obtain a movement of the supporting body 2, and therefore of the extruding unit 10, along the second direction Y in such a way that the first body 21 and the second body 22 slide on the respective guides 102, 103 respectively towards the fourth unit 14 and towards the first unit 11:

by means of the first drive unit 7, the first unit 11 is rotated in a clockwise direction and the third unit 13 is rotated in an anticlockwise direction;

by means of the second drive unit 8, the second unit 12 is rotated in a clockwise direction and the fourth unit 14 is rotated in an anticlockwise direction.

Advantageously, the balancing is maintained in dynamic fashion for all the movements.

A second embodiment of the device 1 is described below with reference to FIG. 4.

The second embodiment comprises at least part of the features of the first embodiment, for which the references introduced are maintained.

Further features are provided below which distinguish the second embodiment with respect to the first embodiment.

The frame 100 comprises at least a fourth guide 104, a fifth guide 105.

The fourth guide 104 and the fifth guide 105 are positioned parallel to the first direction X of the first guide 101.

The frame 100 comprises a sixth guide 106.

The sixth guide 106 is positioned parallel to the second direction Y of the second guide 102.

The motion transmission means 3 are configured to move the sixth guide 106 with respect to the fourth guide 104 and/or to the fifth guide 105.

The supporting body 2 of the extruding unit 10 is slidably constrained to the sixth guide 106 of the frame 100.

The motion transmission means 3 comprise a third body 23.

The third body 23 comprises at least part of the idle units 5 and of the flexible element 4.

The third body 23 is slidably constrained to the fourth guide 104 and is connected to the sixth guide 106.

The third body 23 is interposed between the second unit 12 and the third unit 13.

The motion transmission means 3 comprise a fourth body 24.

The fourth body 24 comprises at least part of the idle units 5 and of the flexible element 4.

The fourth body 24 is slidably constrained to the fifth guide 105 and is connected to the sixth guide 106.

The fourth body 24 is interposed between the fourth unit 14 and the first unit 11.

the fourth guide 104 and the fifth guide 105 are relatively fixed with respect to the movement of the sixth guide 106.

The closed path 6, defined by the flexible element 4, comprises a ninth branch 209 and a tenth branch 210.

The ninth branch 209 and a tenth branch 210 extend along a direction parallel to the first direction X of the first guide 101.

The ninth branch 209 is connected to at least one idle unit 5 of the third body 23.

The tenth branch 210 is connected to at least one idle unit 5 of the fourth body 24.

The closed path 6, defined by the flexible element 4, comprises an eleventh branch 211 and a twelfth branch 212.

The eleventh branch 211 and the twelfth branch 212 extend along a direction parallel to the second direction Y of the second guide 102.

The eleventh branch 211 is connected to at least an idle unit 5 of the third body 23.

The twelfth branch 212 is connected to at least an idle unit 5 of the fourth body 24.

The device 1 comprises an idle unit 5 positioned close to each of the motor-driven units 11, 12, 13, 14 designed to drive the flexible element 4 in such a way that each unit 11, 12, 13, 14 can be wound by a larger portion of the flexible element 4.

Advantageously, in this way the transmission of the motion to the extruding unit is improved.

With reference in particular to the second embodiment illustrated in FIG. 4, but without limiting the scope of the invention, the closed path 6 is described more specifically.

According to this embodiment, the closed path 6, defined by the flexible element 4, comprises at least the second stretch 302, the third stretch 303, the sixth stretch 306, the seventh stretch 307, the ninth stretch 309, the tenth stretch 310, the eleventh stretch 311 and the twelfth stretch 312 with the same features already described.

The seventh branch 207 comprises a fifteenth stretch 315 which connects the idle unit 5 positioned close to the second unit 12 to an idle unit 5 positioned on the third body 23.

The fifteenth stretch 315 is positioned along a direction parallel to the first direction X.

The eighth branch 208 comprises a sixteenth stretch 316 which connects an idle unit 5 positioned on the fourth body 24 to the idle unit 5 positioned close to the first unit 11.

The sixteenth stretch 316 is positioned along a direction parallel to the first direction X.

The ninth branch 209 comprises a seventeenth stretch 317 which connects an idle unit 5 positioned on the third body 23 to the idle unit 5 positioned close to the third unit 13.

The seventeenth stretch 317 is positioned along a direction parallel to the first direction X.

The tenth branch 210 comprises a eighteenth stretch 318 which connects the idle unit 5 positioned close to the fourth unit 14 to an idle unit 5 positioned on the fourth body 24.

The eighteenth stretch 318 is positioned along a direction parallel to the first direction X.

The eleventh branch 211 comprises a nineteenth stretch 319 which connects an idle unit 5 positioned on the third body 23 to an idle unit 5 positioned on the supporting body 2 and also comprises a twentieth stretch 320 which connects an idle unit 5 positioned on the supporting body 2 to an idle unit 5 positioned on the third body 23.

The nineteenth stretch 319 and the twentieth stretch 320 are positioned along a direction parallel to the second direction Y.

The twelfth branch 212 comprises a twenty-first stretch 321 which connects an idle unit 5 positioned on the fourth body 24 to an idle unit 5 positioned on the supporting body 2 and also comprises a twenty-second stretch 322 which connects an idle unit 5 positioned on the supporting body 2 to an idle unit 5 positioned on the fourth body 24.

The twenty-first stretch 321 and the twenty-second stretch 322 are positioned along a direction parallel to the second direction Y.

FIG. 5 describes a non-limiting example of a configuration of the second embodiment of the device 1 for determining a movement of the supporting body 2 and therefore of the extruding unit 10.

By means of the first drive unit 7, the first unit 11 is rotated in a clockwise direction and the third unit 13 is rotated in an anticlockwise direction.

By means of the second drive unit 8, the second unit 12 is rotated in an anticlockwise direction and the fourth unit 14 is rotated in a clockwise direction.

This configuration of the rotations of the motor-driven units (11, 12, 13, 14) determines a resulting force on the supporting body 2 in a direction parallel to the first direction X and with an orientation from the second body 22 to the first body 21.

In other words, according to the drawing in FIG. 5 and the references indicated in it, there is a resultant on the supporting body 2, and therefore on the extruding unit 10, towards the right.

The stretches of the flexible element 4 modify their tension on the basis of the directions of rotation imparted to the motor-driven units (11, 12, 13, 14). Greater or lesser tensions of the stretches themselves translate into forces applied to the first body 21, to the second body 22, to the third body 23, to the fourth body 24 and to the supporting body 2 which are configured to be able to slide on the respective guides (102, 103, 104, 105, 101).

Described below are the forces applied to the first body 21, to the second body 22 to the third body 23, to the fourth body 24 and to the supporting body 2 due to the tensions of the various stretches of the flexible element 4 according to the directions of rotation of the motor-driven units (11, 12, 13, 14) imparted in this example.

It should be noted that the considerations relating to the flexible element 4 described for the first embodiment of the device 1 in use also apply to the second embodiment.

The tension of the second stretch 302 decreases and translates into a force on the second body 22 of equal intensity and direction, but with the opposite orientation, with respect to the force which derives from the tension of the third stretch 303. In fact, the tension of the third stretch 303 also reduces in the same way. For this reason, a zero force is applied to the second body 22, that is to say, it is in equilibrium, with respect to the second direction Y. This results in a zero force along the second direction Y exerted by the second body 22 on the first guide 101 and in particular on the supporting body 2.

The tension of the sixth stretch 306 increases and translates into a force on the first body 21 of equal intensity and direction, but with the opposite orientation, with respect to the force which derives from the tension of the seventh stretch 307. In fact, the tension of the seventh stretch 307 also increases in the same way. For this reason, a zero force is applied to the first body 21, that is to say, it is in equilibrium, with respect to the second direction Y. This results in a zero force along the second direction Y exerted by the first body 21 on the first guide 101 and in particular on the supporting body 2.

The nineteenth stretch 319, twentieth stretch 320, twenty-first stretch 321, twenty-second stretch 322 do not change their tension and do not involve forces on the supporting body 2.

The tensions of the ninth stretch 309 and of the tenth stretch 310 decrease, while the tensions of the eleventh stretch 311 and of the twelfth stretch 312 increase. This translates into a resulting force on the supporting body 2 along the first direction X towards the right, that is to say, towards the first body 21. The fifteenth stretch 315, sixteenth stretch 316, seventeenth stretch 317 and eighteenth stretch 318 do not modify their tension and therefore do not involve forces on the third body 23 and on the fourth body 24.

Repeating, for greater clarity, each force along the second direction Y corresponds to an equal and opposite force, that is to say, there is a zero resultant force along the second direction Y, whilst there is non-zero resulting force along the first direction X towards the first body 21. This results in a movement of the supporting body 2, and therefore of the extruding unit 10, along the first guide 101 towards the first body 21, that is to say, towards the right.

It should be noted that also in the second embodiment the advantages of dynamic balancing present for the first embodiment remain.

It is possible to move the extruding unit 10 according to other uses according to the directions of rotation imparted to the motor-driven units (11, 12, 13, 14). For each movement it is possible to make considerations on the tensions of the stretches of the flexible element 4 and on the forces according to what is described in the above example.

In order to obtain a movement of the supporting body 2, and therefore of the extruding unit 10, along the first direction X of the first guide 101 towards the second body 22: the first unit 11 is rotated in an anticlockwise direction, the third unit 13 is rotated in a clockwise direction, the second unit 12 is rotated in a clockwise direction and the fourth unit 14 is rotated in an anticlockwise direction.

In order to obtain a movement of the supporting body 2, and therefore of the extruding unit 10, along the second direction Y of the sixth guide 106 towards the third body 23: the first unit 11 is rotated in an anticlockwise direction, the third unit 13 is rotated in a clockwise direction, the second unit 12 is rotated in an anticlockwise direction and the fourth unit 14 is rotated in a clockwise direction.

In order to obtain a movement of the supporting body 2, and therefore of the extruding unit 10, along the second direction Y of the sixth guide 106 towards the fourth body 24: the first unit 11 is rotated in a clockwise direction, the third unit 13 is rotated in an anti clockwise direction, the second unit 12 is rotated in a clockwise direction and the fourth unit 14 is rotated in an anti clockwise direction.

Advantageously, the balancing is maintained in dynamic fashion for all the movements.

1. A device for moving an extruding unit of an additive production machine comprising: a frame which comprises at least a first guide positioned along a first direction (X) and a second guide positioned along a second direction (Y) perpendicular to the first direction (X);
a body for supporting the extruding unit slidably constrained at least to the first guide of the frame;
at least a first motor-driven unit, a second motor-driven unit, a third motor-driven unit and a fourth motor-driven unit, or alternatively a fourth idle unit, and means for transmitting the motion of the motor-driven units configured to move the supporting body of the extruding unit with respect to the frame, and configured to move the first guide with respect to the second guide; said motion transmission means comprise a flexible element and a plurality of idle elements;
the flexible element is a single body supported by the first unit, by the second unit, by the third unit, by the fourth unit and by the idle units in such a way as to define a continuous closed path; the continuous closed path extends at least partly along a direction parallel to the first direction (X) of extension of the first guide and along a direction parallel to the second direction (Y) of extension of the second guide.

2. The device according to claim 1, further comprising a first drive unit for driving the first motor-driven unit and the third motor-driven unit and in that it comprises a second drive unit at least for the second motor-driven unit, the first drive unit is configured to control the motion of the first motor-driven unit according to a first direction of movement and of the third motor-driven unit according to a second direction of movement opposite to the first direction and for controlling a same angular movement, in absolute value, of the first motor-driven unit and of the third motor-driven unit, the second drive unit is configured to control at least the motion of the second motor-driven unit according to a first direction of movement and according to an angular movement.

3. The device according to claim 2, wherein the second drive unit is configured to control the fourth motor-driven unit according to a direction of movement opposite to the first direction and to control a same angular movement, in absolute value, of the second motor-driven unit.

4. The device according to claim 1, wherein the distance between the first motor-driven unit and the fourth motor-driven unit, or idle unit, is the same as the distance between the second motor-driven unit and the third motor-driven unit.

5. The device according to claim 1, wherein the motion transmission means comprise a first body comprising at least part of the idle units and of the flexible element; the first body is slidably constrained to the second guide and is connected to the first guide.

6. The device according to claim 1, wherein the frame comprises at least a third guide positioned parallel to the second direction (Y) of the second guide and wherein the motion transmission means comprise a second body comprising at least part of the idle units and of the flexible element; the second body is slidably constrained to the third guide and is connected to the first guide; the second guide and the third guide are relatively fixed with respect to the movement of the first guide.

7. The device according to claim 6, wherein the continuous closed path, defined by the flexible element, comprises at least a first branch, a second branch, a third branch and a fourth branch which extend along a direction parallel to the second direction (Y) of the second guide and wherein the continuous closed path also comprises at least a fifth branch, a sixth branch, a seventh branch and an eighth branch which extend along a direction parallel to the first direction (X) of the first guide;
the first branch and the second branch are each connected to at least one idle unit of the second body;
the third branch and the fourth branch are each connected to at least one idle unit of the first body.

8. The device according to claim 1, wherein the frame comprises at least a fourth guide, a fifth guide and a sixth guide; the fourth guide and the fifth guide are positioned parallel to the first direction (X) of the first guide;
the sixth guide is positioned parallel to the second direction (Y) of the second guide;
the motion transmission means are configured to move the sixth guide with respect to the fourth guide and/or to the fifth guide; said supporting body of the extruding unit is slidably constrained to the sixth guide of the frame.

9. The device according to claim 8, wherein the motion transmission means comprise a third body and a fourth body comprising at least part of the idle units and of the flexible element; the third body and the fourth body are slidably constrained, respectively, to the fourth guide and to the fifth guide and are connected to the sixth guide; the fourth guide and the fifth guide are relatively fixed with respect to the movement of the sixth guide.

10. The device according to claim 9, wherein the closed path, defined by the flexible element, comprises a ninth branch and a tenth branch which extend along a direction parallel to the first direction (X) of the first guide; the ninth branch is connected to at least one idle unit of the third body; the tenth branch is connected to at least one idle unit of the fourth body.

11. The device according to claim 9, wherein the closed path, defined by the flexible element, comprises an eleventh branch and a twelfth branch which extend along a direction parallel to the second direction (Y) of the second guide; the eleventh branch is connected to at least an idle unit of the third body; the twelfth branch is connected to at least an idle unit of the fourth body.

12. The device according to claim 1, wherein the distance between the first motor-driven unit and the second motor-driven unit is the same as the distance between the third motor-driven unit and the fourth motor-driven element or idle unit.

13. The device according to claim 1, wherein the first unit, the second unit, the third motor-driven unit, the fourth unit are supported by the frame in such a way that: the first unit is positioned symmetrical to the second unit with respect to a first axis (A1) of symmetry parallel to the first direction (X) of the first guide (101); the second unit is positioned symmetrical to the third unit with respect to a second axis (A2) of symmetry parallel to the second direction (Y) of the second guide; the fourth unit is positioned in such a way as to be symmetrical to the third unit with respect to the first axis (A1) of symmetry and is positioned in such a way as to be symmetrical to the first unit with respect to the second axis (A2) of symmetry.

14. The device according to claim 1, wherein the flexible element is a belt, the idle units comprise smooth pulleys and/or toothed pulleys and the first unit, the second unit, the third unit and the fourth unit comprise toothed pulleys.
